(19) United States
(12) Patent Application Publication
(10) Pub. No.: US 2012/0033317 A1
(43) Pub. Date: Feb. 9, 2012

(54) POSITION ERROR SIGNAL DEMODULATION WITH TARGET-BASED BLENDING

(75) Inventor: Gabor SZITA, Newark, CA (US)

(73) Assignee: Toshiba America Information Systems, Inc., Irvine, CA (US)

(21) Appl. No.: 12/851,533

(22) Filed: Aug. 5, 2010

(51) Int. Cl. G11B 27/36

(52) U.S. Cl. 360/31; G9B/27.052

(57) ABSTRACT

In a disk drive, a method for servo burst-decoding demodulation that accommodates track pitch variation. Depending on the distance a read head is displaced from a read head target position, a target-based blending scheme, a position-based blending scheme, or a weighted combination of both is used to determine the position of the transducer head. When the transducer head is relatively close to the target position, the target-based blending scheme is used to decode servo bursts and calculate the exact head position. When the transducer head is relatively far from the target position, the position-based blending scheme is used to decode servo bursts and calculate head position. When the transducer head is an intermediate distance from the target position, a weighted combination of the target-based and position-based blending schemes is used.

### BACKGROUND OF THE INVENTION

1. Field of the Invention

Embodiments of the present invention relate generally to disk drives and, more particularly, to systems and methods for demodulating position error signals in such drives.

2. Description of the Related Art

A disk drive is a data storage device that stores digital data in concentric tracks on the surface of a data storage disk. The data storage disk is a rotatable hard disk with a layer of magnetic material thereon, and data is read from or written to a desired track on the data storage disk using a read/write head that is held proximate to the track while the disk spins about its center at a constant angular velocity.

To properly align the read/write head with a desired track during a read or write operation, disk drives generally use a closed-loop servo system that relies on servo data stored in servo sectors written on the disk surface when the disk drive is manufactured. These servo sectors form “servo wedges” or “servo spokes” from the outer to inner diameter of the disk, and are either written on the disk surface by an external device, such as a servo track writer, or by the drive itself using a self servo-writing procedure. The read/write head can be positioned with respect to the data storage disk by using feedback control based on servo information read from the servo wedges with the read element of the read/write head. The servo sectors provide position information about the radial location of the read/write head with respect to the disk surface in the form of servo patterns.

A typical servo pattern consists of a preamble field, a Gray code area and servo bursts, where the servo bursts are used to determine the fine position of the read/write head relative to a specific track. FIG. 1 illustrates servo burst patterns 100, 150 written in adjacent servo sectors k, k+1 on a disk surface. Servo burst pattern 100 includes an AB burst pair 101 and a CD burst pair 102 for track N. Similarly, servo burst pattern 150 includes an AB burst pair 151 and a CD burst pair 152 for track N. For reference, a portion of burst pairs 198, 199 for adjacent track N+1 are also shown in FIG. 1. As a read head 160 travels over servo burst patterns 100, 150 the magnetic transition of the servo bursts generates electrical signals in read head 160. The amplitude of the electrical signals depends on the overlap between read head 160 and the various bursts associated with track N, i.e., AB burst pair 101, CD burst pair 102, AB burst pair 151, CD burst pair 152, and so on. This amplitude information can be used to determine the fine position of the head relative to the servo bursts.

Ideally, when written on a disk surface the servo bursts are uniformly positioned, so that the distance between the AB null point 140 and CD null point 141 are equally spaced for each track and within each sector. In servo sector k, this distance is X1, and in servo sector k−1, this distance is X2. In practice, due to servo writer inaccuracies, distance X1 and X2 vary from track-to-track and from sector-to-sector. The track-to-track variation of average track spacing is typically referred to as DC squeeze or DC track spacing variation and the sector-to-sector variation of track spacing within one track is typically referred to as AC squeeze or AC track spacing variation.

Various burst-decoding schemes are known in the art and can be affected by track squeeze, including stitched demodulation schemes and seamless demodulation schemes. When read head 160 is positioned at some track locations, e.g., between 0 track location (N) and ⅛ track location (N+0.125), the AB burst pairs provide the majority of electrical signals for determining the position of read head 160, while at other track locations, e.g., ½ track location (N+0.5), the CD burst pairs provide the majority of electrical signals. At ¼ track location (N+0.25), however, both the AB burst pairs and the CD burst pairs provide a strong position signal, and generally there is some discontinuity between these two signals at this transition zone, known as “stitching error.”

Stitched burst-decoding demodulation schemes use a weighted combination of the signal provided by an AB burst pair and a CD burst pair to determine a position for read head 160. Stitched demodulation schemes can mathematically ensure that the measured and actual head positions are exactly equal when read head 160 is at the 0 and ½ track locations. Stitched demodulation schemes can be calibrated to accommodate for stitching error that occurs between AB burst pairs and CD burst pairs for nominal track pitch, but because stitching error is greatly exaggerated by track squeeze, such calibration is of limited utility for “squeezed” tracks. Using stitched demodulation schemes, squeezed tracks generally can have undesirable position error signal (PES) noise, or “chatter” at the ¼ track location, which is known to cause data integrity problems.

Seamless burst-decoding demodulation schemes are constructed so that the measured position of read head 160 has no discontinuity between the signals provided by AB burst pairs and CD burst pairs, i.e., the measured position of read head 160 is represented by a continuous curve connecting the AB null and CD null points. This is accomplished by designing seamless demodulation schemes to ensure that the measured and actual head positions are exactly equal when read head 160 is at the 0, ¼, and ½ track locations. FIG. 2 is a graph representing the measured position (ordinate) of read head 160 as a function of the physical position (abscissa) of read head 160, according to a typical seamless burst-decoding demodulation scheme. Curve 201 depicts the measured position of read head 160 for a track having nominal track pitch. As shown, curve 201 is constructed so that at the 0, ¼, and ½ track locations, the measured position is set equal to the physical position of read head 160, thereby defining a continuous curve from the 0 track to the ½ track locations. Because the measured position of read head 160 is defined by such a continuous curve, PES chatter cannot occur. This holds true even when physical track spacing changes due to track squeeze. Curve 202 depicts the measured position of read head 160 for a squeezed track having substantially less than nominal track pitch. Although the physical position of the ¼ track and ½ track locations have moved due to track squeeze, curve 202 is still a continuous curve defining the measured position of read head 160 and PES chatter cannot occur. But because curve 202 has end points and a middle point that are fixed to the actual (squeezed) track locations and not to the nominal 0, ¼ and ½ track locations, the slope 202A of curve 202 is necessarily different than the slope 201A of curve 201. Because servo loop gain for controlling the position of read head 160 is proportional to the slope of curves 201, 202, the servo loop gain changes whenever actual track pitch varies between servo sectors, such as when track squeeze occurs. When the actual track pitch varies between adjacent or proximate servo sectors, as illustrated between servo sectors k and k+1 in FIG. 1, changes in servo loop gain can cause servo loop stability problems, resulting in unwanted oscillations of read head 160.

In light of the above, there is a need in the art for a burst-decoding demodulation method that prevents PES chatter without introducing servo loop instability.

### SUMMARY OF THE INVENTION

One or more embodiments of the present invention provide a method for servo burst-decoding demodulation in a disk drive that accommodates track pitch variation. Depending on the distance a read head is displaced from a read head target position, a target-based blending scheme, a position-based blending scheme, or a weighted combination of both is used to determine the position of the transducer head. When the transducer head is relatively close to the target position, e.g., within ⅛ of a track, the target-based blending scheme is used to decode servo bursts and calculate the exact head position. When the transducer head is relatively far from the target position, e.g., more than ¼ of a track, the position-based blending scheme is used to decode servo bursts and calculate head position. When the transducer head is an intermediate distance from the target position, a weighted combination of the target-based and position-based blending schemes is used.

A method of determining positioning errors of a transducer head of a disk drive, according to an embodiment of the invention, comprises the steps of measuring a position error of the transducer head relative to a nominal target position based on servo bursts written on a recording medium of the disk drive and determining a final position error of the transducer head according to one of a first function, a second function, and a third function. The first function is used when the measured position error is less than a first predetermined number. The second function is used when the measured position error is greater than a second predetermined number. The third function is used when the measured position error is between the first and second predetermined numbers. The first predetermined number represents 12.5% of a nominal track width and the second predetermined number represents 25% of the nominal track width.

A non-transitory computer-readable storage medium, according to an embodiment of the invention, comprises instructions for a processing unit of a disk drive to carry out the steps of measuring a position error of a transducer head of the disk drive relative to a nominal target position based on servo bursts written on a recording medium of the disk drive and determining a final position error of the transducer head according to one of a first function, a second function, and a third function. The first function is used when the measured position error is less than a first predetermined number. The second function is used when the measured position error is greater than a second predetermined number. The third function is used when the measured position error is between the first and second predetermined numbers.

A disk drive, according to an embodiment of the invention, comprises a transducer head, a recording medium having written thereon servo bursts, and a controller for positioning the transducer head over the recording medium using the servo bursts. The controller is programmed to measure a position error of the transducer head relative to a nominal target position based on the servo bursts and determine a final position error of the transducer head according to one of a first function, a second function, and a third function. The first function is used when the measured position error is less than a first predetermined number. The second function is used when the measured position error is greater than a second predetermined number. The third function is used when the measured position error is between the first and second predetermined numbers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates two servo burst patterns written in adjacent servo sectors on a disk surface.

FIG. 2 is a graph representing the measured position of a read head as a function of the physical position of the read head, according to a typical seamless burst-decoding demodulation scheme.

FIG. 3 is a perspective view of a disk drive that can benefit from embodiments of the invention as described herein.

FIG. 4 illustrates a storage disk with data organized in a typical manner known in the art.

FIG. 5 is a graph illustrating an exemplary embodiment of a hybrid curve that represents the measured position of a read head as a function of the physical position of the read head, as determined according to a hybrid burst-decoding demodulation scheme.

FIG. 6 is a graph depicting three curves constructed using a target-based blending scheme for a squeezed track, according to embodiments of the invention.

FIG. 7 is a flow chart that summarizes, in a stepwise fashion, a method of determining the position of a transducer head of a hard disk drive, according to embodiments of the invention.

FIG. 8 is a graph of servo loop gain in a disk drive using a conventional position-based demodulation scheme.

FIG. 9 is a graph of servo loop gain across the sectors of a disk drive using a hybrid demodulation scheme, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

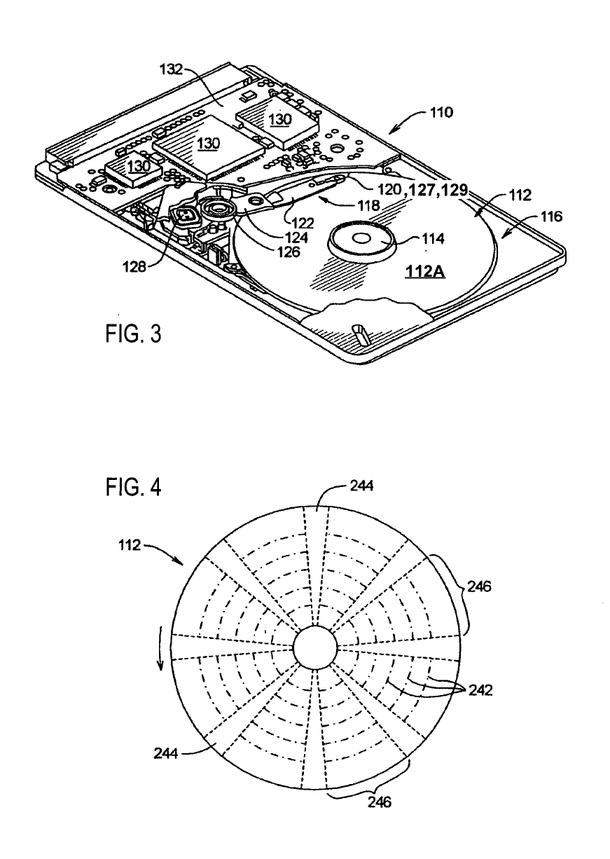

FIG. 3 is a perspective view of a disk drive 110 that can benefit from embodiments of the invention as described herein. For clarity, disk drive 110 is illustrated without a top cover. Disk drive 110 includes a storage disk 112 that is rotated by a spindle motor 114. Spindle motor 114 is mounted on a base plate 116. An actuator arm assembly 118 is also mounted on base plate 116, and has a slider 120 mounted on a flexure arm 122 with a read head 127 and a write head 129. Flexure arm 122 is attached to an actuator arm 124 that rotates about a bearing assembly 126. Voice coil motor 128 moves slider 120 relative to storage disk 112, thereby positioning read and write heads 127 and 129 over the desired concentric data storage track disposed on the surface 112A of storage disk 112. Spindle motor 114, the read and write heads 127 and 129, and voice coil motor 128 are coupled to electronic circuits 130, which are mounted on a printed circuit board 132. The electronic circuits 130 include a read channel, a microprocessor-based controller, and random access memory (RAM). For clarity of description, disk drive 110 is illustrated with a single storage disk 112 and actuator arm assembly 118. Disk drive 110, however, may also include multiple storage disks 112 and multiple actuator arm assemblies 118. In addition, each side of disk 112 may have an associated read and write heads 127 and 129. The invention described herein is equally applicable to devices wherein the individual heads are configured to move separately some small distance relative to the actuator using dual-stage actuation.

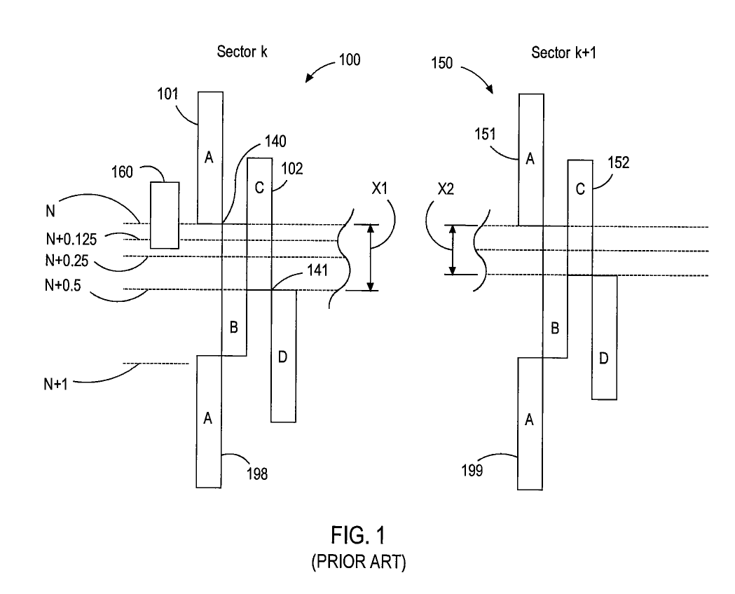

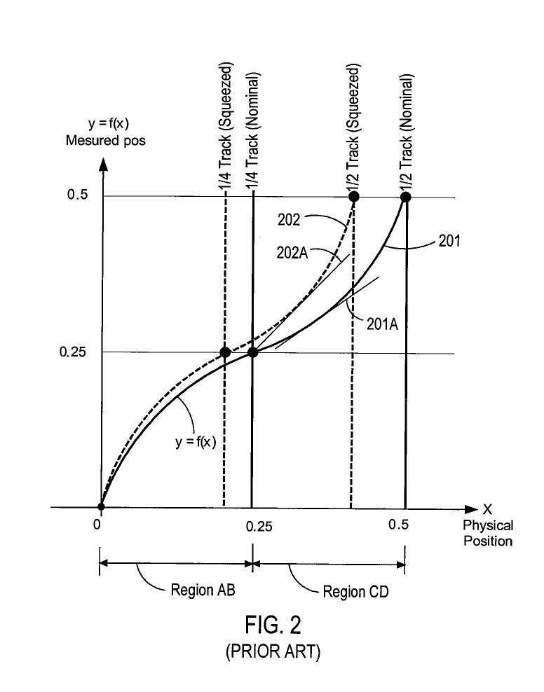

FIG. 4 illustrates storage disk 112 with data organized in a typical manner after servo wedges 244 have been written on storage disk 112 by either a media writer or by disk drive 110 itself via self servo-write (SSW). Storage disk 112 includes data storage tracks 242 located in data sectors 246 for storing data. Data storage tracks 242 are positionally defined by servo information written in servo wedges 244. Each of data storage tracks 242 is schematically illustrated as a centerline, but in practice occupies a finite width about a corresponding centerline. Substantially radially aligned servo wedges 244 are shown crossing data storage tracks 242 and have servo sectors containing servo information. The servo information consists of a preamble field used to synchronize the timing of the read channel and to adjust the signal amplitude, a Gray code area used to determine track number and provide coarse position of read and write heads 127 and 129, and servo bursts used to determine the fine position of read and write heads 127 and 129 relative to a specific data storage track 242. The servo bursts contained in servo wedges 244 may be substantially similar in configuration to servo burst patterns 100, 150 in FIG. 1. Alternatively, the magnetic indicia making up the servo bursts in servo wedges 244 may be configured according to other servo patterns commonly known in the art. In practice, servo wedges 244 may be somewhat curved, for example, configured in a shallow spiral pattern. Further, the actual number of data storage tracks 242 and servo wedges 244 included on storage disk 112 is typically considerably larger than illustrated in FIG. 2. For example, storage disk 112 may include hundreds of thousands of data storage tracks 242 and hundreds of servo wedges 244. As noted above, servo wedges 244 are written on storage disk 112 by either a media writer or by disk drive 110 itself via an SSW process. In either case, due to fluctuations in writing head position that occur during the process of writing servo wedges 244, the majority of data storage tracks 242 vary slightly from the nominal track pitch for disk drive 110, resulting in track squeeze for some of these tracks.

When disk drive 110 is in operation, actuator arm assembly 118 sweeps an arc between an inner diameter (ID) and an outer diameter (OD) of storage disk 112. Actuator arm assembly 118 accelerates in one angular direction when current is passed through the voice coil of voice coil motor 128 and accelerates in an opposite direction when the current is reversed, allowing for control of the position of actuator arm assembly 118 and the attached read and write heads 127 and 129 with respect to storage disk 112. Voice coil motor 128 is coupled with a servo system known in the art that uses positioning data read from storage disk 112 by the read head 127 to determine the position of the read and write heads 127 and 129 over data storage tracks 242. The servo system determines an appropriate current to drive through the voice coil of voice coil motor 128, and drives said current using a current driver and associated circuitry.

Embodiments of the invention provide a method for servo burst-decoding demodulation in a disk drive that accommodates track pitch variation by using a either a target-based blending scheme, a position-based blending scheme, or a weighted combination of both to determine the position of a transducer head, e.g., read head 127 or write head 129. The particular scheme that is used to determine the position of the transducer head depends on the current track position of read head 127 relative to the current target position for read head 127.

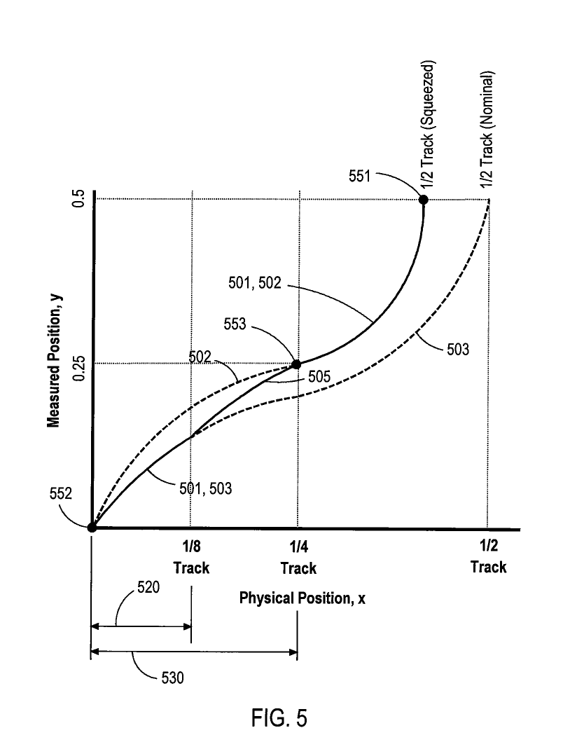

FIG. 5 is a graph illustrating an exemplary embodiment of a hybrid curve 501 (solid line) that represents the measured position (ordinate) of read head 127 as a function of the physical position (abscissa) of read head 127, as determined according to a hybrid burst-decoding demodulation scheme. FIG. 5 also includes a position-based blending scheme curve 502 (dashed line) and a target-based blending scheme curve 503 (dashed line), from which hybrid curve 501 is derived. Position-based blending scheme curve 502 depicts the measured position of read head 127 as a function of the physical position of read head 127, as determined by a position-based blending demodulation scheme. Target-based blending scheme curve 503 depicts the measured position of read head 127 as a function of the physical position of read head 127, as determined by a target-based blending demodulation scheme. As shown, hybrid curve 501, position-based blending scheme curve 502, and target-based blending scheme curve 503 each represent the measured position of read head 127 as a continuous function of physical position, so that no discontinuity occurs as read head travels between the 0 track position and the ½ track position.

According to embodiments of the invention, hybrid curve 501 is derived from position-based blending scheme curve 502 and target-based blending scheme curve 503. Specifically, when read head 127 is relatively close to the target position, the target-based blending scheme is used to decode servo bursts and calculate the exact head position, as indicated by the portion of hybrid curve 501 that is coincident with target-based blending scheme curve 503. When read head 127 is relatively far from the target position, the position-based blending scheme is used to decode servo bursts and calculate head position, as indicated by the portion of hybrid curve 501 that is coincident with position-based blending scheme curve 502. When read head 127 is an intermediate distance from the target position, a weighted combination of the target-based and position-based blending schemes is used, as indicated by segment 505 of hybrid curve 501. In the embodiment illustrated in FIG. 5, the target position for hybrid curve 501 is the 0 track position. The target-based blending scheme is used whenever read head 127 is positioned less than or equal to a first displacement limit 520 from the target position, which in FIG. 5 is ⅛ of a nominal track width. Similarly, the position-based blending scheme is used whenever read head 127 is positioned greater than or equal to a second displacement limit 530 from the target position, which in FIG. 5 is ¼ of a nominal track width. A weighted combination of the position-based blending scheme and the target-based blending scheme is used whenever read head 127 is positioned greater than first displacement limit 520 and less that second displacement limit 530 from the target position. Of course, different values than ⅛ track and ¼ track for first displacement limit 520 and second displacement limit 530, respectively, may be used in some embodiments of the invention. The weighting of the position-based blending scheme and the target-based blending scheme may be linear or of a higher order.

The position-based blending scheme used to generate position-based blending scheme curve 502 may be a conventional seamless burst-decoding demodulation scheme commonly known in the art in which is constructed to ensure that the measured and actual positions of read head 127 are exactly equal when read head 127 is at the 0, ¼, and ½ track locations. Thus an endpoint 551 of position-based blending scheme curve 502 is fixed at the actual ½ track location, which will vary from the nominal ½ track location for squeezed tracks. Similarly, an endpoint 552 of position-based blending scheme curve 502 is fixed at the 0 track location, and a middle point 553 is fixed at the actual ¼ track location. As with the actual ½ track location, the actual ¼ track location will vary from the nominal ¼ track location for squeezed tracks. It is noted that this variance in the location of endpoint 551 and middle point 553 from the nominal ½ track and ¼ track locations, respectively, is what causes the slope of position-based blending scheme curve 502 to vary for squeezed tracks, resulting in servo loop gain changes and potentially servo loop instability. However, embodiments of the invention contemplate using such a position-based blending scheme only when read head 127 is positioned relatively far from the target position, and therefore when the servo loop is performing a seek operation. In such an operation, instability caused by changes in servo loop gain is not likely to occur.

According to embodiments of the invention, a hybrid curve is used to determine the measured position of read head 127 when read head 127 is being controlled by the servo loop of disk drive 110 to a single, specific target position. For example, in FIG. 5, hybrid curve 501 is used to determine the measured position of read head 127 when read head 127 has a target position of 0. For each different target position for read head 127, a unique hybrid curve is used.

A number of seamless burst-decoding demodulation schemes are known in the art and are suitable for use as the position-based blending scheme for constructing position-based blending scheme curve 502. Three seamless burst-decoding demodulation schemes are now provided, although other demodulation schemes known in the art may also be used in some embodiments of the invention. A first seamless burst-decoding demodulation scheme is described by Equations 1A and 1B. Equation 1A defines the position of read head 127 in region AB, i.e., when the actual position of read head 127 is between the 0 track location and the ¼ track location. Equation 1B defines the position of read head 127 in region CD, i.e., when the actual position of read head 127 is between the ¼ track location and the ½ track location.

$$\begin{matrix}y = {f}_{lin} ( 0.5 * \frac{A - B}{\vert C - D \vert} ) & ( 1 A ) \\ y = {f}_{lin} ( 0.5 * \frac{C - D}{\vert A - B \vert} ) & ( 1 B )\end{matrix}$$

where fₗᵢₙ is a suitable linearization function.

A second seamless burst-decoding demodulation scheme is described by Equation 2:

$$y = {f}_{lin} ( \frac{A - B}{\vert A - B \vert + \vert C - D \vert} ) \qquad ( 2 )$$

A third seamless burst-decoding demodulation scheme is described by Equations 3A and 3B:

$$\begin{matrix}y = ( I - {f}_{blend} ) * {f}_{lin} ( \frac{A - B}{\vert A + B \vert} ) + {f}_{blend} * {f}_{lin} ( \frac{C - D}{\vert C + D \vert} ) & ( 3 A ) \\ {f}_{blend} = min ( \frac{\vert A - B \vert}{A - B \vert + \vert C - D \vert} , \frac{\vert C - D \vert}{\vert A - B \vert + \vert C - D \vert} ) & ( 3 B )\end{matrix}$$

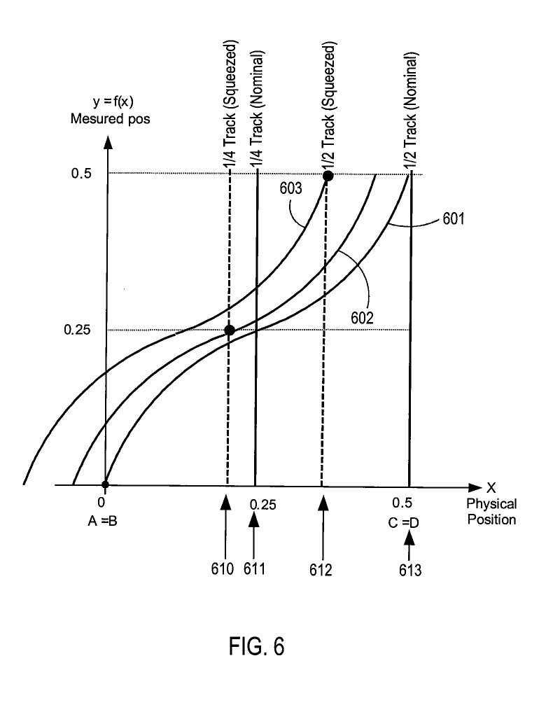

The target-based blending scheme used to generate target-based blending scheme curve 503 is a seamless demodulation scheme similar to the position-based burst-decoding demodulation schemes described in equations 3A and 3B, but with one notable difference. Specifically, target-based blending scheme curve 503 is generated with a fixed shape, and therefore does not change with track squeeze. This is in contrast to position-based blending schemes, in which the shape of a curve representing the measured position of read head 127 is a function of physical position changes shape based on how much track squeeze is present (see, for example, curve 202 in FIG. 2 and position-based blending scheme curve 502 in FIG. 5). In one embodiment, the fixed shape of target-based blending scheme curve 503 is based on a position-based burst-decoding demodulation scheme for a track having nominal track pitch. Thus, in such an embodiment, for a target position set at the 0 track position, target-based blending scheme curve 503 is constructed to begin at the 0 track location, pass through the nominal ¼ track location, and end at the nominal ½ track location. It is noted that for target positions other than the 0 track position, target-based blending scheme curve 503 will not pass through the nominal positions of the 0, ¼, and ½ track locations, as illustrated below in FIG. 6, but will still have the same shape as a curve constructed for a target position set at the 0 track position. Further, the shape of target-based blending scheme curve 503 is the same for squeezed tracks as it is for tracks having nominal track pitch. Another property of target-based blending scheme curve 503 is that said curve is fixed at the target position for read head 127, so that the target position is set equal to the corresponding actual position for that track rather than the corresponding nominal position. For example, for a target position at the ¼ track position for a squeezed track, target-based blending scheme curve 503 is positioned so that a measured position of ¼ track corresponds to the actual (squeezed) ¼ track position, rather than the nominal ¼ track position. This property is illustrated in FIG. 6.

FIG. 6 is a graph 600 depicting three curves 601, 602, and 603 constructed using a target-based blending scheme for a squeezed track, according to embodiments of the invention. For clarity, curves for only three target positions are illustrated in FIG. 6, but in practice a different curve is constructed for each target position of read head 127. Curve 601 is positioned for a target position at the 0 track position, curve 602 is positioned for a target position at the ¼ track position, and curve 603 is positioned for a target position at the ½ track position. Curve 601 is a continuous curve and, because it is selected for a target position at the 0 track position, passes through the nominal 0 track, ¼ track, and ½ track positions. It is noted that in this way, curve 601 is substantially similar to target-based blending scheme curve 503 in FIG. 5. Curves 602 and 603 are constructed with the same shape as curve 601, but are translated to different locations in graph 600 so that the target position is aligned with the corresponding actual position for the track and not with the corresponding nominal position for the track. Thus, for a squeezed track, curve 602 is positioned in graph 600 so that the target position of ¼ track is aligned with the actual ¼ track location 610 of the squeezed track and not the nominal ¼ track location 611. Similarly, curve 603 is positioned in graph 600 so that the target position of ½ track is aligned with the actual ½ track location 612 of the squeezed track and not the nominal ½ track location 613. Consequently, when using curves 601, 602, 603, the measured position of read head 127, i.e., the ordinate of graph 600, equals the target position when read head 127 is aligned with the corresponding actual position rather than with the nominal position. For example, given a target position for read head 127 of ¼ track, curve 602 is used to determine the measured position of read head 127 as a function of the physical position of read head 127. As shown in FIG. 6, curve 602 is positioned in graph 600 so that the measured position of read head 127 equals the target position of ¼ track when read head 127 is aligned with the ¼ track position 610 of the squeezed track rather than with the nominal ¼ track position.

Because each of curves 601, 602, 603 have identical shapes by definition, there is no change is slope between curves 601, 602, 603 regardless of track squeeze, thereby avoiding unwanted servo gain variation due to track squeeze. In addition, because the hybrid burst-decoding demodulation scheme described above in conjunction with FIG. 5 only uses the portion of curves 601, 602, 603 proximate the target position, i.e., the portions within first displacement limit 520 of the target position, the large position error associated with using such fixed-shape curves is also avoided.

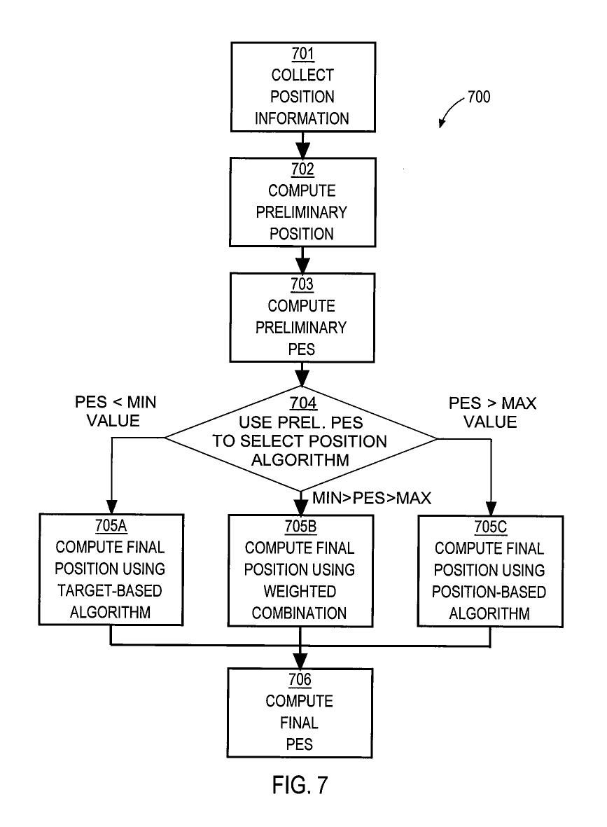

FIG. 7 is a flow chart that summarizes, in a stepwise fashion, a method 700 of determining the position of a transducer head of a hard disk drive, according to embodiments of the invention. Method 700 is described in terms of a disk drive substantially similar to disk drive 110 in FIG. 3. However, other disk drives may also benefit from the use of method 700. The commands for carrying out steps 701-705 may reside in the disk drive control algorithm and/or as values stored in the electronic circuits of the disk drive or on the storage disk itself.

In step 701, position information is collected from burst pairs on a recording medium. The position information is read by read head 127 as it passes over the burst pairs, e.g., an AB burst pair and a CD burst pair. The raw position of read head 127 is computed based on the position information from each burst pair. In one embodiment, raw position is computed in step 701 using Equations 4A, 4B:

$$\begin{matrix}{N}_{1} = \frac{A - B}{A + B + C + D} & ( 4 A ) \\ {Q}_{1} = \frac{C - D}{A + B + C + D} & ( 4 B )\end{matrix}$$

In some embodiments, Equations 5A and 5B may be used to compute linearized positions using the raw positions computed using Equations 4A, 4B:

N=ƒₗᵢₙ(N₁) (5A)

Q=ƒₗᵢₙ(Q₁) (5B)

In step 702, a preliminary position of read head 127 is computed using a position-based blending scheme using Equations 6A, 6B to calculate the measured position. Alternatively, other methods may be used to estimate the position of read head 127. For example, the measured position computed in step 702 using a target-based blending scheme may be used.

$$\begin{matrix}{y}_{pos} = {b}_{pos} N + ( 0.5 - {b}_{pos} ) Q & ( 6 A ) \\ {b}_{pos} = \frac{min ( \vert N \vert , \vert Q \vert )}{\vert N \vert + \vert Q \vert} & ( 6 B )\end{matrix}$$

In step 703, a preliminary PES of read head 127 is determined. In a preferred embodiment, the measured position computed in step 702 using the position-based blending scheme, i.e., Equations 6A, 6B, is compared to the target position of read head 127.

In step 704, the preliminary PES is compared to first displacement limit 520 and second displacement limit 530 to select what algorithm is used to calculate the final measured position of read head 127. When the preliminary PES of read head 127 is determined to be less than or equal to first displacement limit 520 from the target position, the final measured position of read head 127 is equal to a measured position determined using Equations 7A, 7B, which is a target-based blending scheme:

y_{t arg}=b_{t arg}N+(0.5−b_{t arg})Q (7A)

b_{t arg}=min(x_{t arg},0.5−x_{t arg}) (7B)

When the preliminary position of read head 127 is determined to be greater than or equal to second displacement limit 530 from the target position, the final measured position of read head 127 is equal to the measured position determined in step 702 using Equations 6A, 6B, which is a position-based blending scheme. When the preliminary position of read head 127 is determined to be less than second displacement limit 530 from the target position and greater than first displacement limit 520 from the target position, the final measured position of read head 127 is determined by Equation 8, which is a weighted combination of the target-based blending scheme described by Equations 7A, 7B and the position-based blending scheme described by Equations 6A, 6B:

y=w*yₚₒₛ+(1.0−w)*y_{t arg} (8)

where w is a typical weighting function, that may be a function of the preliminary PES calculated in step 703, first displacement limit 520, and second displacement limit 530. A typical weighting function is:

$$w = \frac{\vert {e}_{pre} \vert - \vert {L}_{t arg} \vert}{{L}_{pos} - {L}_{t arg}} \qquad ( 9 )$$

where eₚᵣₑ is the prelimnary PES, L_{targ} is the first displacement limit and Lₚₒₛ is the second displacement limit.

In steps 705A-705C, the final measured position of head 127 is computed using the algorithm determined in step 704. In step 705A, the final measured position of read head 127 is determined using Equations 7A, 7B, which is a target-based blending scheme. In step 705C, the final measured position of read head 127 is determined using Equations 6A, 6B, which is a position-based blending scheme. And in step 705B, the final measured position of read head 127 is determined by Equation 8, which is a weighted combination of the target-based blending scheme described by Equations 7A, 7B and the position-based blending scheme described by Equations 6A, 6B.

In step 706, the final PES of head 127 is computed using the final measured position for head 127 determined in one of steps 705A, 705B, and 705C.

Method 700 is described herein for write operations by disk drive 110. However, method 700 may also be used beneficially for read operations, according to embodiments of the invention. For read operations, a micro-jog value may be used to determine the position of write head 129 once the position of read head 127 is computed. Such a micro-jog value may be provided by consulting a conventional micro-jog calibration curve.

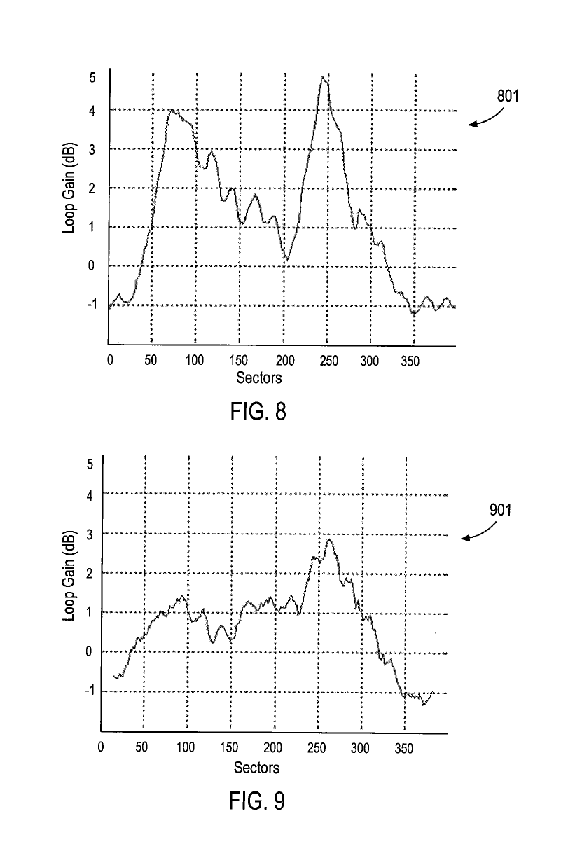

FIG. 8 is a graph 801 of servo loop gain in a disk drive using a conventional position-based demodulation scheme. FIG. 9 is a graph 901 of servo loop gain across the sectors of a substantially similar disk drive using a hybrid demodulation scheme, according to embodiments of the invention. As shown, loop gain variation is significantly reduced in graph 901.

In sum, embodiments of the invention have the significant advantage of avoiding PES chatter associated with stitched servo-burst demodulation schemes when demodulating position information from a storage disk. In addition, embodiments of the invention avoid the gain variation and related servo loop instability associated with seamless servo-burst demodulation schemes.

While the foregoing is directed to embodiments of the present invention, other and further embodiments of the invention may be devised without departing from the basic scope thereof, and the scope thereof is determined by the claims that follow.

I claim:

1. A method of determining positioning errors of a transducer head of a disk drive, comprising the steps of:
measuring a position error of the transducer head relative to a nominal target position based on servo bursts written on a recording medium of the disk drive; and
determining a final position error of the transducer head according to one of a first function, a second function, and a third function,
wherein the first function is used when the measured position error is less than a first predetermined number, and the second function is used when the measured position error is greater than a second predetermined number, and the third function is used when the measured position error is between the first and second predetermined numbers.

2. The method of claim 1, wherein the servo bursts include a first pair and a second pair and each of the first and second functions is a weighted sum of position information estimated from the first pair and position information estimated from the second pair.

3. The method of claim 2, wherein weights applied in the first function are varied based on the nominal target position.

4. The method of claim 2, wherein weights applied in the second function are varied based on the position information estimated from the first pair and the position information estimated from the second pair.

5. The method of claim 1, wherein the third function is a weighted sum of the first function and the second function.

6. The method of claim 5, wherein weights applied in the third function are varied based on the measured position error.

7. The method of claim 1, wherein the first predetermined number represents 12.5% of a nominal track width and the second predetermined number represents 25% of the nominal track width.

8. A non-transitory computer-readable storage medium comprising instructions for a processing unit of a disk drive to carry out the steps of:
measuring a position error of a transducer head of the disk drive relative to a nominal target position based on servo bursts written on a recording medium of the disk drive; and
determining a final position error of the transducer head according to one of a first function, a second function, and a third function,
wherein the first function is used when the measured position error is less than a first predetermined number, and the second function is used when the measured position error is greater than a second predetermined number, and the third function is used when the measured position error is between the first and second predetermined numbers.

9. The non-transitory computer-readable storage medium of claim 8, wherein the servo bursts include a first pair and a second pair and each of the first and second functions is a weighted sum of position information estimated from the first pair and position information estimated from the second pair.

10. The non-transitory computer-readable storage medium of claim 9, wherein weights applied in the first function are varied based on the nominal target position.

11. The non-transitory computer-readable storage medium of claim 9, wherein weights applied in the second function are varied based on the position information estimated from the first pair and the position information estimated from the second pair.

12. The non-transitory computer-readable storage medium of claim 8, wherein the third function is a weighted sum of the first function and the second function.

13. The non-transitory computer-readable storage medium of claim 12, wherein weights applied in the third function are varied based on the measured position error.

14. The non-transitory computer-readable storage medium of claim 8, wherein the first predetermined number represents 12.5% of a nominal track width and the second predetermined number represents 25% of the nominal track width.

15. A disk drive comprising:
a transducer head;
a recording medium having written thereon servo bursts; and
a controller for positioning the transducer head over the recording medium using the servo bursts, the controller being programmed to measure a position error of the transducer head relative to a nominal target position based on the servo bursts and determine a final position error of the transducer head according to one of a first function, a second function, and a third function,
wherein the first function is used when the measured position error is less than a first predetermined number, and the second function is used when the measured position error is greater than a second predetermined number, and the third function is used when the measured position error is between the first and second predetermined numbers.

16. The disk drive of claim 15, wherein the servo bursts include a first pair and a second pair and each of the first and second functions is a weighted sum of position information estimated from the first pair and position information estimated from the second pair.

17. The disk drive of claim 16, wherein weights applied in the first function are varied based on the nominal target position.

18. The disk drive of claim 16, wherein weights applied in the second function are varied based on the position information estimated from the first pair and the position information estimated from the second pair.

19. The disk drive of claim 15, wherein the third function is a weighted sum of the first function and the second function.

20. The disk drive of claim 19, wherein weights applied in the third function are varied based on the measured position error.
